(19) United States
(12) Patent Application Publication
(10) Pub. No.: US 2010/0013329 A1
(43) Pub. Date: Jan. 21, 2010

(54) Oil cooled electric drive module for hybrid vehicles

(76) Inventors: David C. Heidenreich, Akron, OH (US); Steven A. Caskey, North Lawrence, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/218,593

(22) Filed: Jul. 17, 2008

(51) Int. Cl. H02K 9/19

(52) U.S. Cl. 310/54

(57) ABSTRACT

An oil cooled electric drive module for hybrid vehicles includes an AC motor assembly having a shaft parallel to an output shaft, with the shafts being interconnected by a set of helical reduction gears. The motor shaft is provided with a rotary union for cooling oil that passes first axially and then radially through the shaft to an outer circumferential surface thereof beneath the core of a rotor attached thereto. The cooling oil passes beneath the rotor to the outer ends thereof, where annular deflectors disburse the oil to provide a coanda effect over the shorting rings of the rotor, onto the stator windings, and thence onto the motor housing for return to a cooling sump, which may include hydraulic and electric pumps for further desired cooling circulation. The invention also includes solenoid valves for shifting a splined collar between positions of interconnection and disconnection between the motor shaft and output shaft. The module of the invention is adapted for interpositioning within the drive shaft of a motor vehicle, with the output shaft of the module being connected at opposite ends to the vehicle drive shaft.

### TECHNICAL FIELD

The invention herein resides in the art of hybrid vehicles, particularly of the type adapted for implementation of alternate drive sources. Particularly, the invention relates to a module including an electric drive motor adapted for selective interconnection with the drive shaft of a vehicle to alternatingly provide an electric motor or heat engine as the power source for the vehicle drive mechanism. Specifically the invention relates to a post transmission hybrid drive module having parallel motor and output shafts, the output shaft being interconnected with the drive shaft of a vehicle and the motor shaft being selectively engageable with the output shaft.

### BACKGROUND OF THE INVENTION

The cost of heat sources for the engines typically employed for driving vehicles has given rise to an acute need for alternative fuels or hybrid vehicles, adapted for implementation of various fuel sources. Presently, the most advantageous type of an alternate fuel vehicle is the hybrid vehicle, which, in its most common sense, employs a diesel or gas powered engine and an electric motor as alternative power sources. Prior attempts to achieve this combination have generally met with disappointment, being either excessively costly or under powered in providing motive force. Moreover, the packaging of alternative power sources has been given to complexities that have yet to be overcome, resulting in vehicles that are not only costly, but given to service and maintenance problems. Moreover, presently known electric motors and their methods of implementation have been fraught with power output that is inconsistent with the bulk, size, weight and cost of the motor being implemented.

The instant invention provides a module for use with electric vehicles, hybrid electric vehicles, plug-in hybrid electric vehicles and other applications requiring high performance, light weight, and economical electric motors and/or generators. It is known that the alternating current (AC) induction motor is the simplest and least expensive type of electric motor for vehicle traction drives. The advent of Flux Vector inverter drive controls provides for variable frequency control up to very high speeds for standard induction motors. Standard motors are typically wound for the common 60 hertz frequency that is used in the United States, or 50 hertz, which is used for the most part in the remainder of the world. High frequency motor invertor drives can operate into the range of 200 to 400 hertz, resulting in motor speeds up to 12,000 rpm for common four pole motors that normally run at 1,800 rpm. A properly matched controller and high speed motor can produce 3 to 5 times the peak power from a similarly sized standard AC induction motor. Further, with effective cooling such a motor can produce 5-10 times the continuous power rating of a standard fan cooled motor and even well beyond that of water jacket cooled motors. Particularly problematic is the need for removal of the heat in the rotor core and stator windings to achieve high continuous power.

It is well known that an AC induction motor commonly uses a “squirrel cage” rotor as its only rotating part. In overall shape, the rotor is a cylinder mounted on a shaft. Internally, it contains axial or longitudinal conductive bars of aluminum or copper set in grooves or holes in the rotor laminations and connected at both ends by shorting rings of aluminum or copper to form a cage-like conductive structure. The core of the rotor is built up of a stack of iron laminations. The field winding in the stator of an induction motor sets up a rotating magnetic field around the rotor. The relative motion between this field and the rotation of the rotor induces electric current flow in the conductive bars. In turn, these currents flowing lengthwise in the conductors react with the magnetic field of the motor stator windings to produce a force acting at a tangent to the rotor, resulting in torque to turn the motor shaft. In effect, the rotor is carried around with a magnetic field, but at a slightly slower rate of rotation. The difference in speed is called “slip” and increases with load.

### DISCLOSURE OF THE INVENTION

In light of the foregoing, it is an aspect of the invention to provide an oil cooled electric drive module for hybrid vehicles that can significantly reduce the weight and cost of electric motors for vehicle traction drives.

A further aspect of the invention is the provision of an oil cooled electric drive module for hybrid vehicles that employs a high speed motor with a gear reduction capable of matching the output speed with desired vehicle speed at which the electric drive is most useful.

Still a further aspect of the invention is the provision of an oil cooled electric drive module for hybrid vehicles that is particularly adapted for implementation with vehicles such as urban buses, refuse trucks, and the like, having a staged gear reduction achieving the desired match between motor speed an output drive speed.

Yet a further aspect of the invention is the provision of an oil cooled electric drive module for hybrid vehicles which may be quickly and effectively engaged and disengaged with the vehicle drive shaft.

Another aspect of the invention is the provision of an oil cooled electric drive module for hybrid vehicles that is efficiently cooled by implementation of a coanda effect distribution of cooling oil across the rotor and stator of the motor and its housing.

Still a further aspect of the invention is the provision of an oil cooled electric drive module for hybrid vehicles that employs a rotary union on the motor drive shaft with axial and radial passages for motor cooling oil to optimize the cooling effect.

An additional aspect of the invention is the provision of an oil cooled electric drive module for hybrid vehicles that includes the implementation of a heat exchanger to optimize cooling efficiency.

Yet a further aspect of the invention is the provision of an oil cooled electric drive module for hybrid vehicles that includes a manifold connected to and driven by the motor output shaft to optimize shifting speed and efficiency between power sources.

Still a further aspect of the invention is the provision of an oil cooled electric drive module for hybrid vehicles that includes a motor driven pump that provides for the actuation pressure for shifting between power sources, and the flow of oil through a heat exchanger mechanism.

Yet a further aspect of the invention is the provision of an oil cooled electric drive module for hybrid vehicles that is readily conducive to implementation with presently known heated vehicles, providing an auxiliary driving force for such vehicles.

The foregoing and other aspects of the invention that will become apparent as the detailed description proceeds are achieved by a post transmission parallel hybrid drive module for vehicles, comprising: an AC induction motor having a motor shaft extending therethrough, said motor shaft having a rotor attached thereto, said rotor being received within an array of stator windings, and said motor shaft having a passage therein for passing cooling oil over opposite ends of said rotor and onto said stator windings; a sump adjacent said motor for receiving cooling oil from said windings; an output shaft passing through said sump, said output shaft adapted at opposite ends thereof for interposition within a drive shaft of a vehicle; and a gear assembly interposed between said motor shaft and output shaft for selective driving engagement therebetween.

Other aspects of the invention are attained by a post transmission parallel hybrid drive module for a vehicle, comprising: an AC induction motor having a motor shaft extending therethrough, said motor shaft having a rotor attached thereto, said rotor being received within an array of stator windings, and said motor receiving cooling oil over opposite ends of said rotor and onto said stator windings; a sump adjacent said motor for receiving cooling oil from said windings; an output shaft passing through said sump and adapted at opposite ends thereof for interposition within a drive shaft of a vehicle; and a gear assembly interposed between said motor shaft and output shaft for selective driving engagement therebetween.

Still further aspects of the invention are attained by a post transmission parallel hybrid drive module for a vehicle, comprising: an AC induction motor having a motor shaft extending therethrough, said motor shaft having a rotor attached thereto, said rotor being received within an array of stator windings about a stator core, said motor receiving cooling oil over opposite ends of said rotor and onto said stator windings, and said stator core having a circumferential passage thereabout receiving cooling oil about a circumferential surface of said stator core; a sump adjacent said motor for receiving cooling oil from said windings and stator core; an output shaft adapted at opposite ends thereof for interposition within a drive shaft of a vehicle; and a gear assembly interposed between said motor shaft and output shaft for selective driving engagement therebetween.

### DESCRIPTION OF DRAWINGS

For a complete understanding of the various aspects of the invention, reference should be made to the following detailed description and accompanying drawings wherein:

FIG. 1 is a front elevational view of the oil cooled electric drive module for hybrid vehicles made in accordance with the invention;

FIG. 2 is a cross sectional view of the assembly of FIG. 1, taken along the line 2-2;

FIG. 3 is a cross sectional view of the assembly of FIG. 1, taken along the line 3-3;

FIG. 4 is a cross sectional view of an alternate embodiment of the invention, showing the implementation of an auxiliary pump manifold; and

FIG. 5 is a schematic diagram of the implementation of the auxiliary pump manifold of FIG. 4.

### BEST MODE FOR CARRYING OUT THE INVENTION

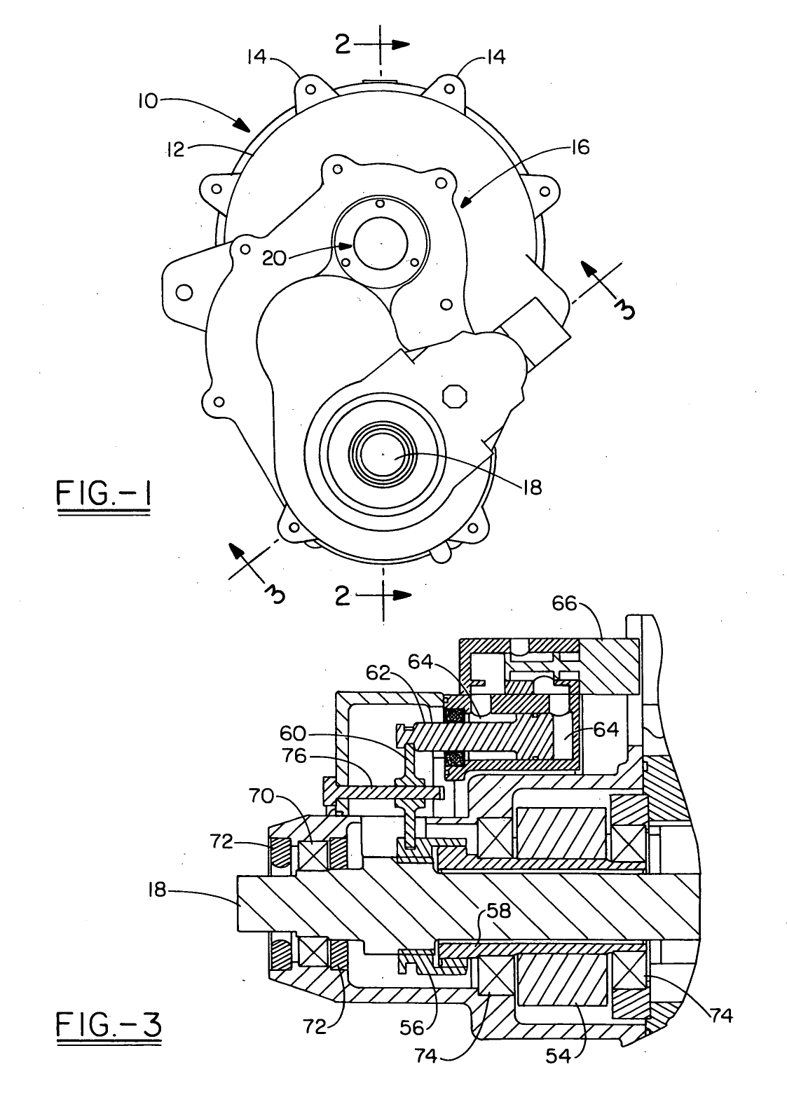

Referring now to the drawings and more particularly FIGS. 1-3, it can be seen that an oil cooled electric drive module for hybrid vehicles is designated generally by the numeral 10. The module 10 includes a housing 12, typically made of aluminum or the like. The housing 12 is characterized by mounting flanges or ears 14 provided thereabout and suitable for mounting of the module 10 to a desired vehicle. A housing cap 16, also preferably of aluminum, is bolted to the housing 12, as shown.

Received within the housing 12, comprising halves 12a and 12b, is a drive shaft or output shaft 18, having respective ends 18a, 18b adapted for interconnection with the drive shaft of a vehicle. In other words, the drive shaft 18 is adapted to be interposed within the drive shaft of the vehicle, beyond the vehicle's transmission, and interconnected therewith through universal joints or the like at 18a and 18b. Also received within the housing 12 and maintained in parallel relationship to the drive shaft 18, is a motor shaft 20 of a motor having a squirrel cage configuration. The motor includes a stator core 22 having stator windings 24 thereabout in standard fashion, the stator core and windings being fixedly retained in the housing 12. A rotor base 26, of standard fashion, is connected to the motor shaft 20 and is rotatable therewith. In standard fashion, conducive bars 28 extend axially across the rotor base 22 and are interconnected as by shorting rings 30 at the lateral ends thereof.

Appropriate bearings 32 are provided at opposite ends of the motor shaft 20 for rotational support. A speed sensing bearing 34, appropriately encoded or otherwise graduated for producing signals corresponding to rotational speed, is provided at one end of the motor shaft 20. At the opposite end, an oil distribution ring assembly or rotary union is attached to the motor shaft 20 and is provide in communication with an axial bore 38 extending thereinto. The axial bore 38 extends to and communicates with a radial bore 40 that extends outwardly into communication with the outer circumferential surface of the motor shaft 20. A plurality of axial splines or reliefs 42 are provided in the circumferential surface of the motor shaft 20 and extend between end rings 44, provided at each end of the rotor base. The end rings 44 are in the form of annular disks, washers, deflectors or the like. This structure and arrangement provides an important pathway for cooling oil to enter the motor shaft 20 at the oil distribution ring or rotary union 36, to pass through the axial bore 38, outwardly through the radial bore 40, and into the space between the shaft 20 and rotor base 26. The plurality of axial splines or reliefs 42 provided in the circumferential surface of the shaft 20 direct the cooling oil outwardly between the shaft and rotor base to the end rings 44, where the cooling oil is redirected radially by such deflectors at the end of the rotor. There, the cooling oil is centrifugally spun outwardly with a coanda effect that coats the aluminum or copper shorting rings 30 on the end faces of the rotor. This oil is centrifugally thrown off of the rotor directly into the stator windings 24 to then flow downwardly through the motor to drain holes 46 in the aluminum housing 12 and into a recovery and recirculating sump 48, that receives the drive shaft 18. A drain 50 is provided within the sump 48 to return the cooling oil to an appropriate pump, auxiliary heat exchanger, or the like for redistribution back through the assembly 10 or other units associated with the vehicle.

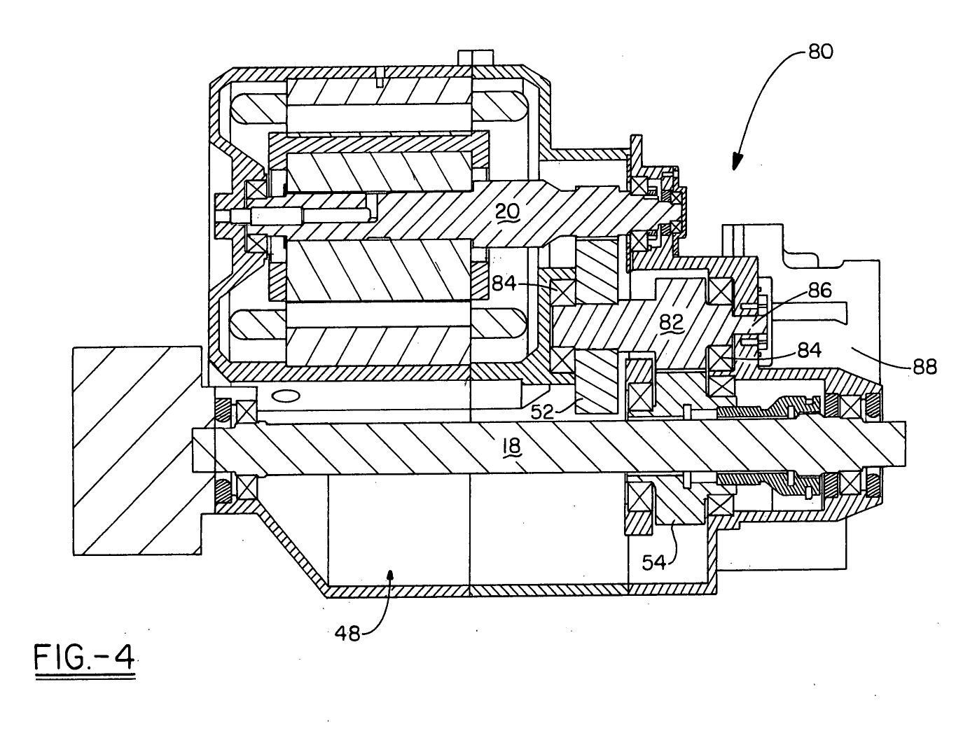

The invention employs a gear reduction set between the motor shaft 20 and output shaft 18 to tailor the motor speed to a desired output speed. In one embodiment, the gear set includes a first stage helical gear 52 in driving connection through gear teeth with the motor shaft 20. Those skilled in the art will understand that the first stage helical gear 52 is connected through an appropriate gear drive shaft ( shown in FIG. 4) to a second stage helical gear 54 which, in turn, is selectively connected to the output shaft 18 through an appropriate mechanical disconnect mechanism 56, best shown and described with regard to FIG. 3.

The mechanical disconnect mechanism 56 is operatively connected to a splined collar 58 that is interposed between the second stage helical gear 54 and the output shaft 18. The collar 58 is axially slidable with regard to both the output shaft 18 and gear 54 to selectively engage and disengage the two. An actuator arm 60 is interconnected with the mechanical disconnect mechanism 56 and driven by a hydraulic piston 62 upon a slide 76, as shown. The piston 62 is received by a hydraulic cylinder 64, having dual cavities to both extend and retract the piston 64 with respect thereto. Accordingly, the piston 62 is capable of engaging and disengaging the collar 58 through the disconnect mechanism 56 and associated actuator arm 60. A solenoid valve 66 is electrically operated to selectively actuate the piston 64 in either the engage or disengage direction.

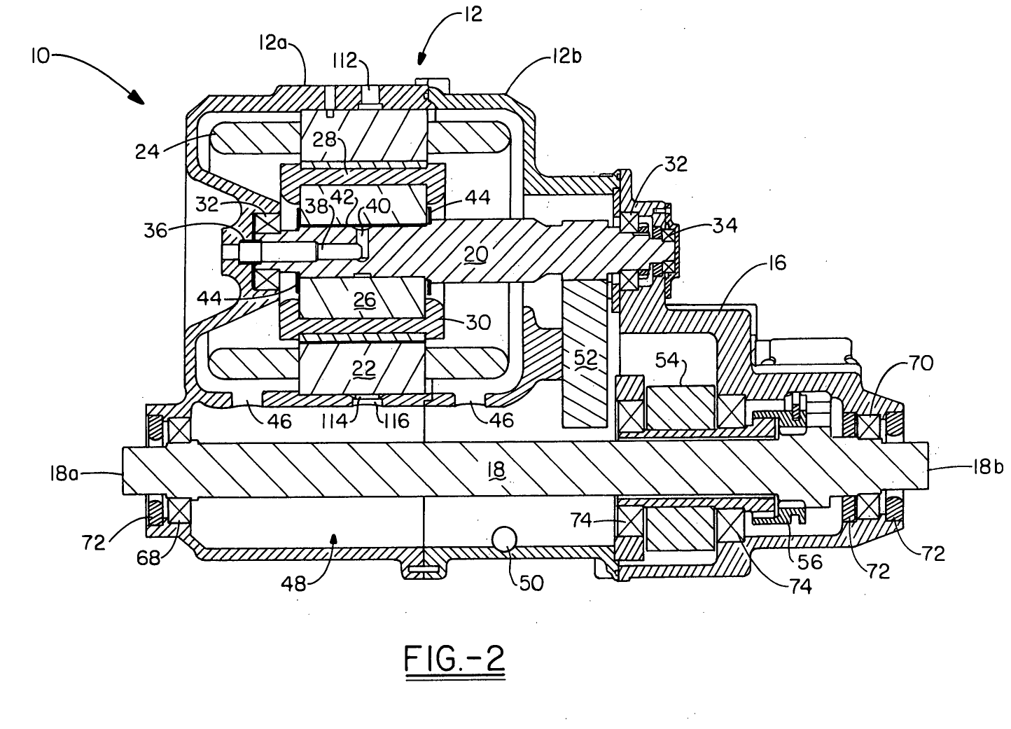

As shown in FIG. 2, the output shaft 18 is supported at opposite ends 18a, 18b by an appropriate bearing 68. A speed sensing bearing 70, similar to the bearing 34, is provided at the end 18b, as shown. Appropriate keepers or seals 72 are provided at opposite ends of the output shaft 18 for purposes of sealing and maintaining the shaft 18 within the housing 12, 16, as shown. Appropriate bearings 74 are provided for the splined collar 58 and second stage gear 54.

In use, it will be appreciated that the solenoid valves 66 may be employed to selectively engage/disengage the motor drive from the output shaft 18. The timing of the engagement/disengagement is achieved by correlation of the outputs of the speed sensing bearings 34, 70. When disengaged, the output shaft 18 is driven solely by the heat engine of the vehicle. When engaged, the motor drive mechanism either provides sole power to the vehicle (in which case the heat engines are disengaged from the output shaft 18) or the motor is used to supplement that power. Of key importance is the ability to provide an AC motor structure that can be effectively cooled in order to ensure optimum efficiency in a small, light weight, cost effective envelope. The provision of an oil distribution ring assembly or rotary union 36 in association with axial and radial bores 38, 40, coupled with the implementation of axial splines or reliefs 42 and end ring deflectors 44 to provide a coanda sheeting of cooling oil across the end surface of the rotor which is then centrifugally spun outwardly onto the stator of the motor, and its housing, providing for effective cooling that optimizes motor performance.

FIG. 4 presents an alternative embodiment of the invention, similar in most respects to the embodiment presented in FIGS. 1-3, but with the addition of an auxiliary pump manifold to further optimize the cooling required for improved performance. This second embodiment 80 shows the presence of the gear drive shaft 82 interposed between the first and second stage helical gears 52, 54 and maintained upon bearings 84. This gear drive shaft 82 is provided with an output head 86 to provide power to an auxiliary pump manifold 88, illustratively shown as connected thereto.

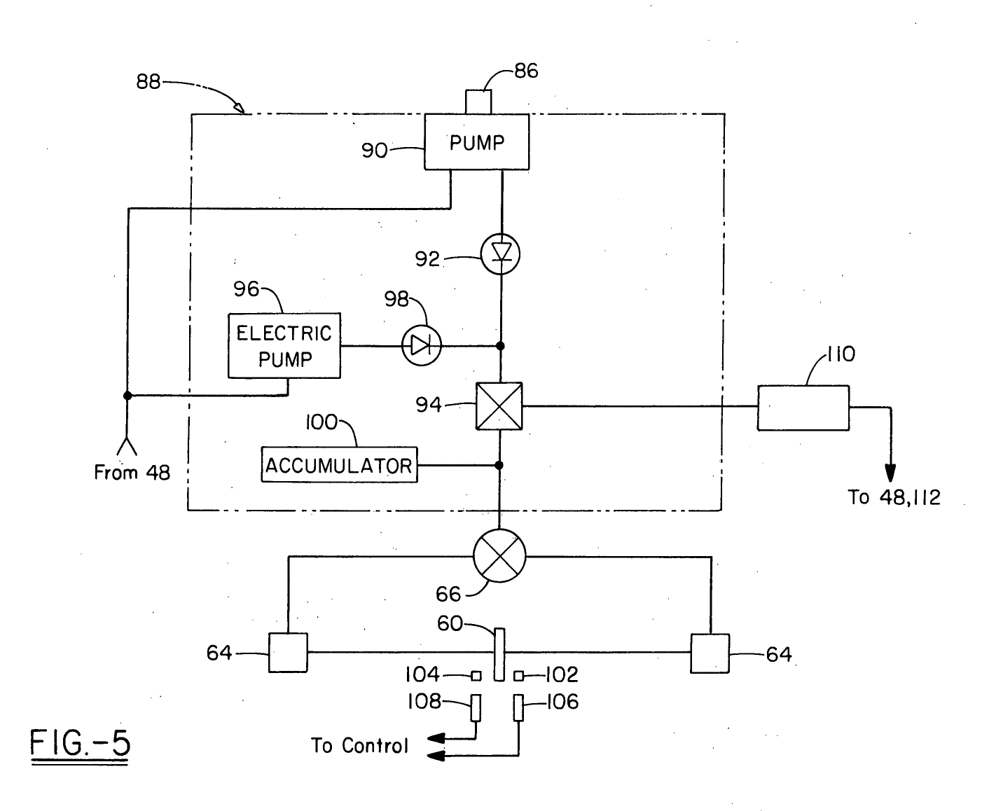

As shown in FIG. 5, the output head 86 of the gear drive shaft 82, operatively driven by the motor shaft 20, provides motor force to the auxiliary pump manifold 88, that includes a hydraulic pump 90, receiving cooling oil from the sump 48. The cooling oil is driven by the pump 90 through a check valve 92 and thence to a pressure relief valve 94, as shown. Also included within the auxiliary pump manifold 88 is an electric pump 96, similarly connected to the sump 48 for receiving cooling oil therefrom and passing it through the check valve 98 and the pressure relief valve 94. Accordingly, both mechanically and electrically driven pumps 90, 96 are provided for purposes of cooling oil recirculation and provision to the solenoid valves 66 responsible for engagement and disengagement of the electric motor power source with the output shaft 18. The output of the pressure relief valve 94 is provided to an accumulator 100, in somewhat standard fashion. The output of the accumulator 100 is interconnected with the solenoid valves 66 for selectively pressurizing the hydraulic cylinder 64 for driving the actuator arm 60 in a selected direction to effect engagement or disengagement of the motor shaft 20 with the output shaft 18.

A pair of permanent holding magnets 102, 104 is employed to hold the actuator arm 60 in a desired position, once moved by the piston 62. Accordingly, the piston, cylinders, and solenoid valve 66 are employed to move the actuator arm 60 to either engage or disengage the output shaft 18 with the second stage gear 54, and the actuator arm 60 is then maintained in that position by an appropriate holding magnet 102, 104 such that the hydraulic pressure can be released, and not reapplied until opposite shifting is desired. In that regard, proximity sensors 106, 108 are provided in association with the actuator arm 60 or other associated movable element, to sense that the desired shifting has occurred and then signal through an appropriate control mechanism that the solenoid valves 66 can be released for removal of the hydraulic pressure.

The instant invention further contemplates that an auxiliary heat exchanger 110 may be interposed between the pressure relief valve 94 and the sump 48 for further cooling efficiency. The heat exchanger 110 may be of any suitable nature, such as a radiator, finned housing, cooling jacket or the like. The necessity of transferring heat from the motor assembly to the ambient is of primary importance to ensure optimum effective operation of the motor. In keeping with such efforts to maximize and optimize cooling of the drive motor, it is further contemplated as a portion of the cooling oil recirculation that the output of the pump 90 or heat exchanger 110 might also provide additional cooling to the stator core 22 and windings 24. To that end, as shown in FIGS. 2 and 5, the output of the heat exchanger 110 may pass to the stator core inlet 112, through the circumferential cooling path 114 encircling the stator core 22, out of the drain 116 and into the sump 48.

Thus it can be seen that the various aspects of the invention have been attained by the structures and combinations thereof presented herein. While in accordance with the patent statutes only the best mode and preferred embodiments of the invention have been presented and described in detail, the invention is not limited thereto or thereby. Accordingly, for an appreciation of the true scope and breadth of the invention reference should be made to the following claims.

What is claimed is:

1. A post transmission parallel hybrid drive module for a vehicle, comprising:
an AC induction motor having a motor shaft extending therethrough, said motor shaft having a rotor attached thereto, said rotor being received within an array of stator windings, and said motor shaft having a passage therein for passing cooling oil over opposite ends of said rotor and onto said stator windings;
a sump adjacent said motor for receiving cooling oil from said windings;
an output shaft adapted at opposite ends thereof for interposition within a drive shaft of a vehicle; and
a gear assembly interposed between said motor shaft and output shaft for selective driving engagement therebetween.

2. The post transmission parallel hybrid drive module for a vehicle according to claim 1, wherein said passage comprises axial and radial bores within said motor shaft, and further comprises an oil distribution ring mounted on an end of said motor shaft and in communication with said bores.

3. The post transmission parallel hybrid drive module for a vehicle according to claim 2, wherein said passage extends axially from an end of said motor shaft and thence radially to an opening in a surface of said motor shaft beneath said rotor.

4. The post transmission parallel hybrid drive module for a vehicle according to claim 3, wherein said opening in said surface extends to a circumferential passage between said rotor and said motor shaft.

5. The post transmission parallel hybrid drive module for a vehicle according to claim 4, wherein said circumferential passage is defined by grooves within said surface of said motor shaft.

6. The post transmission parallel hybrid drive module for a vehicle according to claim 5, further characterized by deflectors extending outwardly from said surface of said motor shaft on opposite ends of said rotor, said deflectors positioned to provide a coanda effect by developing a sheet of oil over at least a portion of said rotor as said rotor spins.

7. The post transmission parallel hybrid drive module for a vehicle according to claim 6, wherein said deflectors are further configured and positioned to direct oil onto said array of stator windings.

8. The post transmission parallel hybrid drive module for a vehicle according to claim 3, further comprising an oil distribution ring assembly connected to said end of said motor shaft from which said passage extends axially.

9. The post transmission parallel hybrid drive module for a vehicle according to claim 1, wherein said output shaft and motor shaft are substantially parallel, and further comprising a gear reduction assembly interposed between said motor shaft and output shaft.

10. The post transmission parallel hybrid drive module for a vehicle according to claim 1, further comprising a disconnect between said motor shaft and output shaft, said disconnect comprising a piston and cylinder reciprocatingly engaging a member operatively interposed between said motor shaft and output shaft.

11. The post transmission parallel hybrid drive module for a vehicle according to claim 10, wherein said cylinder is a hydraulic cylinder operated with cooling oil from said sump to selectively engage and disengage said motor shaft and output shaft with each other.

12. The post transmission parallel hybrid drive module for a vehicle according to claim 11, further comprising an auxiliary hydraulic pump manifold operatively interposed between said motor shaft and said piston and cylinder, said manifold comprising a hydraulic pump operatively driven by said motor shaft and operatively connected to said piston and cylinder.

13. The post transmission parallel hybrid drive module for a vehicle according to claim 12, further comprising a heat exchanger interposed between said hydraulic pump and said sump.

14. The post transmission parallel hybrid drive module for a vehicle according to claim 13, wherein said manifold further comprises an electric pump interposed between said sump and said heat exchanger, and operatively driving said piston and cylinder.

15. The post transmission parallel hybrid drive module for a vehicle according to claim 10, wherein said member is movable between first and second positions, respectively engaging and disengaging said motor shaft and output shaft and wherein said disconnect further comprises a pair of permanent holding magnets, one at each of said first and second positions for holding said member at said associated position until released therefrom by said piston and cylinder.

16. The post transmission parallel hybrid drive module for a vehicle according to claim 10, wherein said member is movable between first and second positions, and further comprising a proximity sensor associated with each of said first and second positions, said proximity sensors emitting signals when said member reaches an associated first or second position.

17. The post transmission parallel hybrid drive module for a vehicle according to claim 10, wherein said member comprises an actuation arm operatively connected to a splined collar slidably interposed between said output shaft and said gear reduction assembly.

18. The post transmission parallel hybrid drive module for a vehicle according to claim 10, wherein said gear reduction assembly is double staged and selectively interengageable between said motor shaft and output shaft.

19. A post transmission parallel hybrid drive module for a vehicle, comprising:
an AC induction motor having a motor shaft extending therethrough, said motor shaft having a rotor attached thereto, said rotor being received within an array of stator windings, and said motor receiving cooling oil over opposite ends of said rotor and onto said stator windings;
a sump adjacent said motor for receiving cooling oil from said windings;
an output shaft passing through said sump and adapted at opposite ends thereof for interposition within a drive shaft of a vehicle; and
a gear assembly interposed between said motor shaft and output shaft for selective driving engagement therebetween.

20. The post transmission parallel hybrid drive module for a vehicle according to claim 19, wherein said output shaft and motor shaft are substantially parallel, and further comprising a gear reduction assembly interposed between said motor shaft and output shaft.

21. The post transmission parallel hybrid drive module for a vehicle according to claim 19, further comprising a disconnect between said motor shaft and output shaft, said disconnect comprising a piston and cylinder reciprocatingly engaging a member operatively interposed between said motor shaft and output shaft.

22. The post transmission parallel hybrid drive module for a vehicle according to claim 21, wherein said member is movable between first and second positions, respectively engaging and disengaging said motor shaft and output shaft and wherein said disconnect further comprises a pair of permanent holding magnets, one at each of said first and second positions for holding said member at said associated position until released therefrom by said piston and cylinder.

23. The post transmission parallel hybrid drive module for a vehicle according to claim 21, wherein said gear reduction assembly is double staged and selectively interengageable between said motor shaft and output shaft.

24. A post transmission parallel hybrid drive module for a vehicle, comprising:
an AC induction motor having a motor shaft extending therethrough, said motor shaft having a rotor attached thereto, said rotor being received within an array of stator windings about a stator core, said motor receiving cooling oil over opposite ends of said rotor and onto said stator windings, and said stator core having a circumferential passage thereabout receiving cooling oil about a circumferential surface of said stator core;
a sump adjacent said motor for receiving cooling oil from said windings and stator core;
an output shaft adapted at opposite ends thereof for interposition within a drive shaft of a vehicle; and
a gear assembly interposed between said motor shaft and output shaft for selective driving engagement therebetween.

25. The post transmission parallel hybrid drive module for a vehicle according to claim 24, wherein said output shaft and motor shaft are substantially parallel, and further comprising a gear reduction assembly interposed between said motor shaft and output shaft.

26. The post transmission parallel hybrid drive module for a vehicle according to claim 25, further comprising a disconnect between said motor shaft and output shaft, said disconnect comprising a piston and cylinder reciprocatingly engaging a member operatively interposed between said motor shaft and output shaft.

27. The post transmission parallel hybrid drive module for a vehicle according to claim 26, wherein said member is movable between first and second positions, respectively engaging and disengaging said motor shaft and output shaft and wherein said disconnect further comprises a pair of permanent holding magnets, one at each of said first and second positions for holding said member at said associated position until released therefrom by said piston and cylinder.

28. The post transmission parallel hybrid drive module for a vehicle according to claim 25, wherein said gear reduction assembly is double staged and selectively interengageable between said motor shaft and output shaft.
